(19) United States
(12) Patent Application Publication
(10) Pub. No.: US 2024/0235906 A1
(43) Pub. Date: Jul. 11, 2024

(54) PRECODING DURING LINK ESTABLISHMENT

(71) Applicant: Intel Corporation, Santa Clara, CA (US)

(72) Inventors: Andrew K. LILLIE, Chandler, AZ (US); Itamar LEVIN, Holon (IL); Yaniv SABAG, Kfar Shmuel (IL); Kent C. LUSTED, Aloha, OR (US)

(21) Appl. No.: 18/143,034

(22) Filed: May 3, 2023

Related U.S. Application Data
(60) Provisional application No. 63/433,647, filed on Dec. 19, 2022.

(51) Int. Cl. H04L 25/49; H04L 25/03

(52) U.S. Cl. CPC H04L 25/4917; H04L 25/03012

(57) ABSTRACT

Examples described herein relate to an Ethernet physical layer transceiver (PHY) circuitry for use in frame communication with a remote link partner. In some example, the Ethernet PHY circuitry can include Physical Medium Dependent (PMD) circuitry and transmitter circuitry and receiver circuitry for use in the frame communication. In some examples, the PMD circuitry is to perform link training with a partner transmitter and selectively request the partner transmitter to apply a modulation scheme with precoding during the link training based on a magnitude of one or more equalizer coefficient values.

### RELATED APPLICATION

This application claims priority to U.S. Provisional Application No. 63/433,647, filed Dec. 19, 2022. The entire contents of that application are incorporated by reference in their entirety.

### DESCRIPTION

Link training is a process used by a device connected through a copper cable, backplane, or other wired or wireless signal transmission media to another device, by which the transmitter and receiver communicate with one other in order to tune equalizer settings to mitigate frequency dependent signal attenuation. Link training can provide for tuning of a finite impulse response (FIR) filter for a channel in an application-specific integrated circuit (ASIC) or other device to achieve the desired bit error rate (BER), eye size, signal-to-noise ratio (SNR), or link error rate (e.g., uncorrectable and correctable forward error correction (FEC) errors, pseudorandom bit sequence (PRBS) errors, physical coding sublayer (PCS) errors, and so forth).

### BRIEF DESCRIPTION OF THE DRAWINGS

FIG. 1 depicts an example of equalizer.

FIG. 2 depicts an example training sequence.

FIG. 3 depicts an example process.

FIGS. 4A-4D depict example excerpts from IEEE 802.3-2022.

FIG. 5 depicts an example of potential use of an 800GMII (800 Gb/s media independent interface).

FIGS. 6A-6C depict example systems.

FIG. 7 depicts a system that can perform link monitoring.

FIG. 8 depicts a network interface

FIG. 9 depicts an example computing system.

FIG. 10 depicts an example computing system.

### DETAILED DESCRIPTION

Precoding encodes a bitstream prior to transmission and can improve performance of equalizers at a receiver. Precoding is a mathematical technique to break an error into entry error and exit error. In accordance with IEEE 802.3-2022, Clause 136, and similar clauses, Ethernet links at data rates of 50 Gbps per lane and higher speed are required to implement precoding capability for Pulse Amplitude Modulation 4-level (PAM-4) modulation on the transmitted bit-stream to help reduce the likelihood of bursts of errors in the receiver due to feedback and sequence dependent equalizers (e.g., Decision Feedback Equalizer (DFE), Maximum Likelihood Sequence Estimation (MLSE), or others). A burst of errors can result in uncorrectable errors despite application of Forward Error Correction (FEC). If a burst of errors is expected, precoding at a transmitter can improve performance of equalizers at a receiver. If bursts of errors are not expected (e.g., errors are randomly distributed), precoding at a transmitter may not be desirable because error multiplication may arise when resolving to entry and exit errors.

Some examples provide circuitry and/or processor-executed software in a receiver to determine whether to request precoding during a training phase of link establishment based on measurements made by the receiver based on received training patterns. Precoding can be requested during a training phase of link establishment and can be finalized before exiting the training phase. For example, a receiver can determine whether to request a transmitter to apply precoding based on a converged response of the Decision Feedback Equalizer (DFE) coefficients in the receiver. If the magnitude of a normalized value of DFE tap coefficient at an equalizer of the receiver is at or above a pre-determined threshold (e.g., 0.5 or other values), the risk of a burst of errors may be sufficiently high and the receiver can request that the transmitter apply precoding to transmitted training or data signals. In some examples, a training protocol allows the receiver to request the partner transmitter (e.g., transmitter that transmits the training signal to the receiver) to enable precoding to be applied to signals transmitted to the receiver. Precoding requests by the receiver to the transmitter can be enabled, disabled, or allowed to be determined automatically.

For example, in addition to, or as an alternative to selecting use of precoding, devices can tune equalizer settings of at least one serializer/deserializer (SerDes) using link training. For example, a transmitter (Tx) can generate training data and send the training data to a receiver (Rx) and based on analysis of the training signal, the receiver can provide feedback to the transmitter to tune equalizer settings of the transmitter. For example, a receiver could select to request transmission with PAM-4 and precoding applied when a receiver utilizes a DFE, Maximum Likelihood Sequence Estimation (MLSE)-based equalizer, continuous linear time equalizer (LTE), feed forward equalizer (FFE), or other equalizer type. Accordingly, a receiver can request adjustment of transmitter equalizer coefficients (e.g., pre-cursor, main, or post-cursor coefficients), modulation scheme (e.g., PAM-2 or PAM-4) and precoding (e.g., such as using PAM-4 modulation). For example, a transmitter can apply precoding of the transmitted bit stream using 1/(1+D) mod 4 precoding, such as that described in IEEE Standard 802.3-2022, Clause 135.5.7.2. Receivers may optionally provide the ability to decode the precoded data and request precoding during control function link training.

For a link trained to operate at 50 Gbps per lane, or higher speeds, Ethernet links between two partners can use a Physical medium dependent (PMD) Control Function based at least on IEEE Std. 802.3-2022 Clause 136.8.11 to perform a startup protocol. As part of the startup protocol, a local receiver can request changes to operations of the partner's transmitter to adjust and potentially improve received signal quality. If the receiver requests that its link partner transmitter change the precursor, main cursor, or post-cursor equalization setting, the eye examination process may begin again. In some examples, the receiver examines a signal eye after applying equalization to the signal and determines if eye height and/or eye width is within a configured parameter. The receiver can determine to terminate link training because the eye is acceptable, or continue training to adjust the eye parameters further. Factors other than signal can be analyzed by the receiver to determine whether to continue or terminate link training.

As link partners both include a transmitter and receiver, a link partner can train the opposite partner's transmitter, simultaneously or after training a transmitter-receiver pair. After the link is trained, the two devices can send data traffic (e.g., non-training signals) with applied precoding.

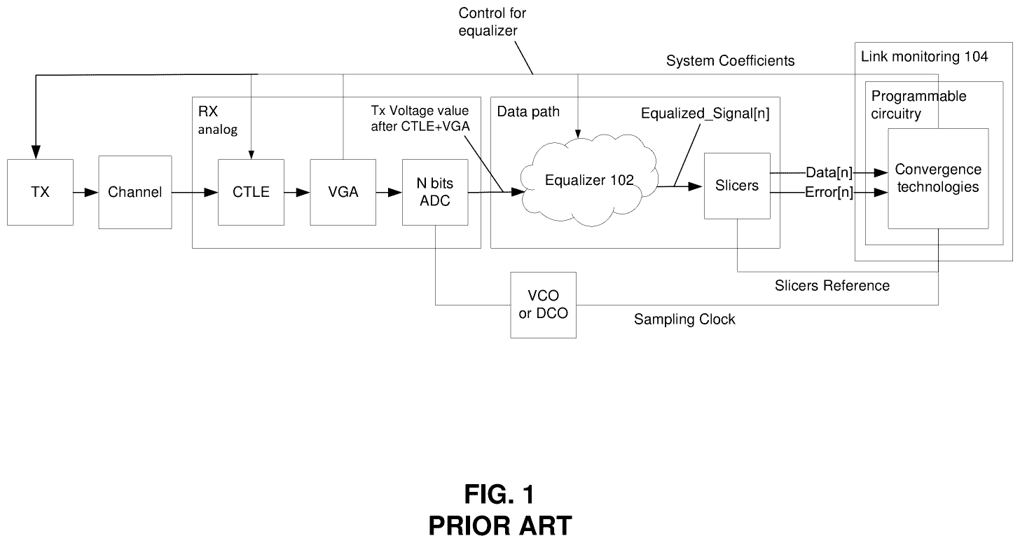

FIG. 1 shows an example of a receiver architecture. A signal received from a channel (e.g., signal propagation media) can be equalized and conditioned by continuous time linear equalizer (CTLE) and variable gain amplifier (VGA), sampled by an analog to digital converter (ADC) and further equalized using programmable circuitry. Decisions (e.g., Data[n]) can be made on the received bits using slicers, and the error between the equalized signal and the decision can be calculated (e.g., Error[n]=Equalized Signal[n]−Data[n]).

Equalizer 102 can include equalizers such as FFE and/or DFE and its output can be used to determine ISI. Link monitoring 104 of a PHY can compute metrics of residual ISI (un-equalized inter-symbol interference (ISI) and reflection related ISI after detecting the reflection on the pulse response (based on the scan described earlier). Link monitoring 104 of a physical layer interface (PHY) can perform ISI detection that operates non-destructively to a normal operation of the link since it used during mission-mode traffic. Link monitoring 104 can measure the channel ISI caused by insertion loss and reflections. Link monitoring 104 can receive the receiver error signal and the detected data stream and determine whether changes in ISI tap values are indicative of deterioration of a link or channel or poor mating of a connection. For example, link monitoring 104 can calculate a projection of the n^{th} tap ISI on the error signal by integrating Error[n]*Data[n−k] for the n^{th} tap of ISI. For a sequence of measurements with n values, different taps of ISI can be measured, and a pulse response of the system can be mapped. The value of n can be negative or positive to estimate pre-cursor or post-cursor ISI taps. To determine a span of a reflection (n range), a threshold can be set and tap batches that exceed the threshold can be counted or identified as reflection ISI. Tap batches that do not exceed the threshold can be considered noise. In some examples, link monitoring circuitry 104 can be implemented as a processor or microcontroller executed process, field programmable gate array (FPGA), application specific integrated circuit (ASIC), or other programmable hardware device.

The use of precoding can mitigate the likelihood of a burst of errors which result when an incorrect decision (a bit error) is made in the receiver concerning a particular bit and the magnifying effect of this error by the DFE and a coefficient. When a sample results in a bit error and this sample is multiplied by the DFE coefficient to the subsequent bits as part of the echo cancellation function of DFE, the application of that coefficient can cause that sampled bit to be evaluated incorrectly (e.g. a ‘0’ is recorded instead of the true value of ‘1’) and lead to another bit error. This bit error, in turn, can result in another bit error and so on until the coefficient decays.

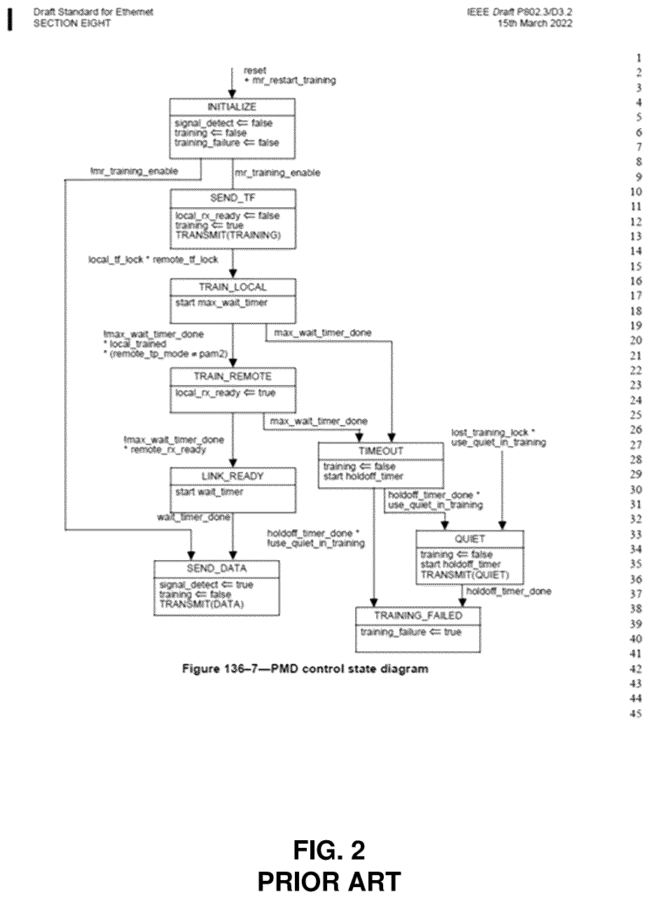

FIG. 2 depicts an example of PMD control state diagram reproduced from IEEE 802.3-2022. A transmitter and receiver pair can apply operations of the state diagram to change transmitter equalization coefficients, either to predefined initial conditions or by individual coefficient control.

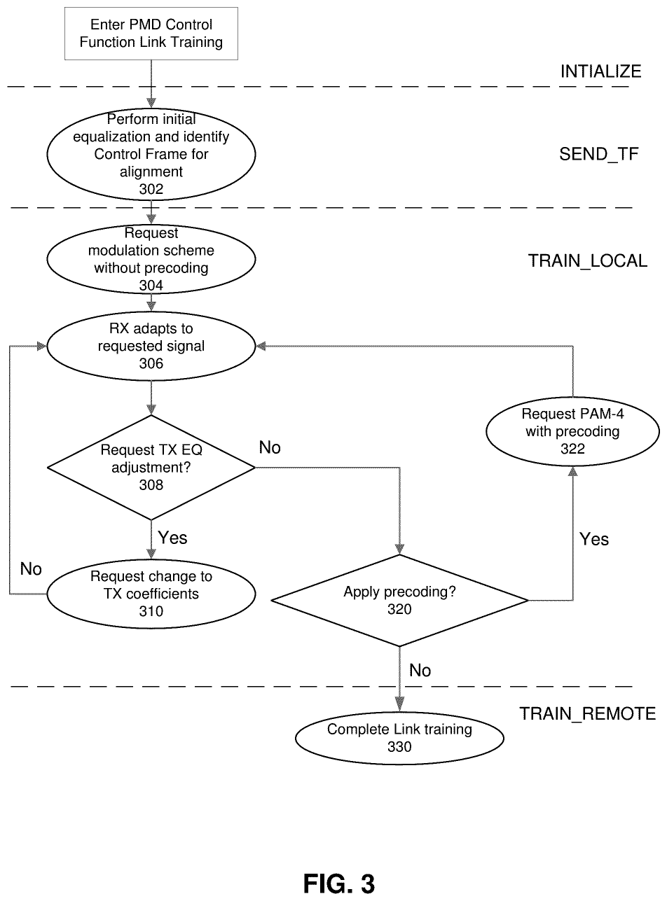

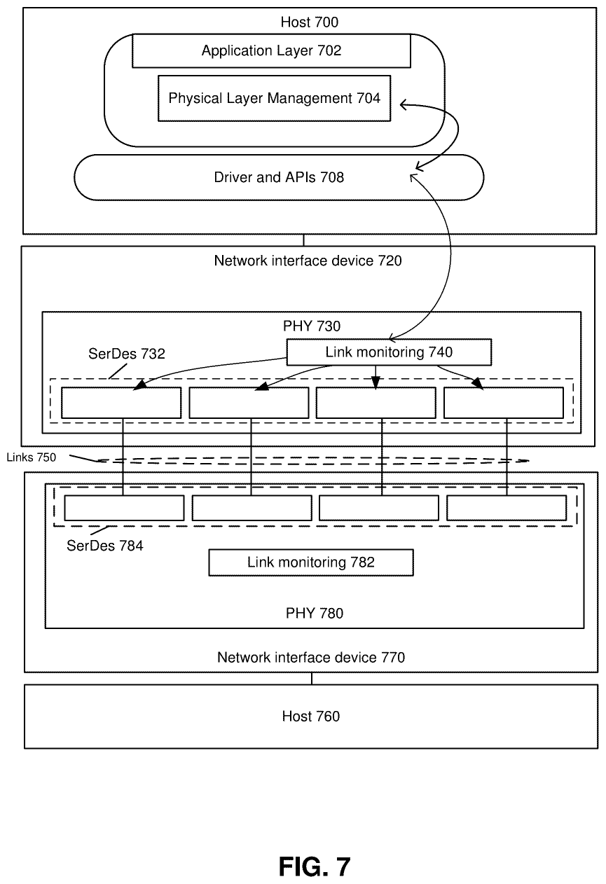

FIG. 3 shows a process that can be utilized by a receiver to determine when to enable precoding of data by a transmitter. The process can be used in conjunction at least with the control state diagram shown in FIG. 2. For example, a PMD of a receiver, implemented as one or more of: firmware, software, and/or hardware, can perform the training process at least of FIG. 136-7 of IEEE 802.3-2022. FIG. 136-7 of IEEE 802.3-2022 provides an example startup operation for a transmitter. However, examples can apply to earlier or later versions of 802.3-2022 or variations thereof or other standards. Some examples utilize a Control Function training, in which a receiver can converge its equalizer to the incoming signal and adjust its DFE coefficients, or other parameters. A receiver can request precoding by the transmitter and the receiver can be retrained based on monitored absolute magnitude of the DFE coefficients exceeding a programmable threshold.

This process assumes that automatic determination of precoding is enabled. If precoding is permanently enabled or disabled at the beginning of this flow, this process can complete after arriving at a TX EQ setting. During an INITIALIZE phase of FIG. 2, PMD Control Function Link Training can be entered. For example, INITIALIZE phase can refer to a state of a transmitter and receiver pair prior to a transmitter sending a training signal. During SEND_TF phase of FIG. 2, a receiver (RX) locks to an incoming training signal sent by a transmitter. During SEND_TF, at 302, initial equalization and identification of a Control Frame for alignment can commence, in accordance with IEEE Standard 802.3-2022 Clause 136.8.11 and FIG. 136-7. For example, SEND_TF phase can refer to a state in which a transmitter is to transmit training signals to a receiver.

During TRAIN_LOCAL phase of FIG. 2, at 304, the receiver can request transmission of training signals encoded using a modulation scheme (e.g., PAM-4) without precoding transmitted via one or more lanes to a receiver. For example, TRAIN_LOCAL phase can refer to a state in which link training occurs for a particular amount of time. Example training signals include training signals generated by pseudorandom binary sequence 13 (PRBS13) polynomials based on seed values. During TRAIN_LOCAL, at 306, the receiver can adapt to the training signal by performance of receiver equalization tap optimization. During TRAIN_LOCAL, a receiver can perform initial equalization and identify at least one Control Frame for alignment. An example Control Frame is defined at least in IEEE 802.3-2022, section 136.8.11.1.

During TRAIN_LOCAL, at 308, a receiver can determine whether to request a transmitter PMD to adjust one or more equalizer (EQ) settings based on an adaptation scheme. The adaptation scheme can determine whether equalization in receiver, transmitter, or receiver and transmitter is to be performed to improve a quality of a received signal on a lane. Example adaptation schemes include least mean square (LMS) error indication to determine how to adjust transmitter equalizer setting(s) to reduce slope of LMS error.

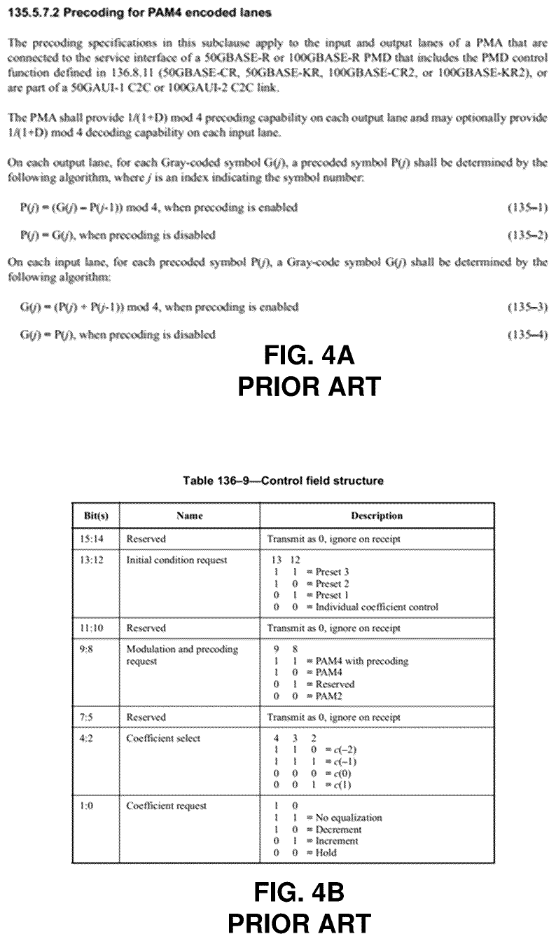

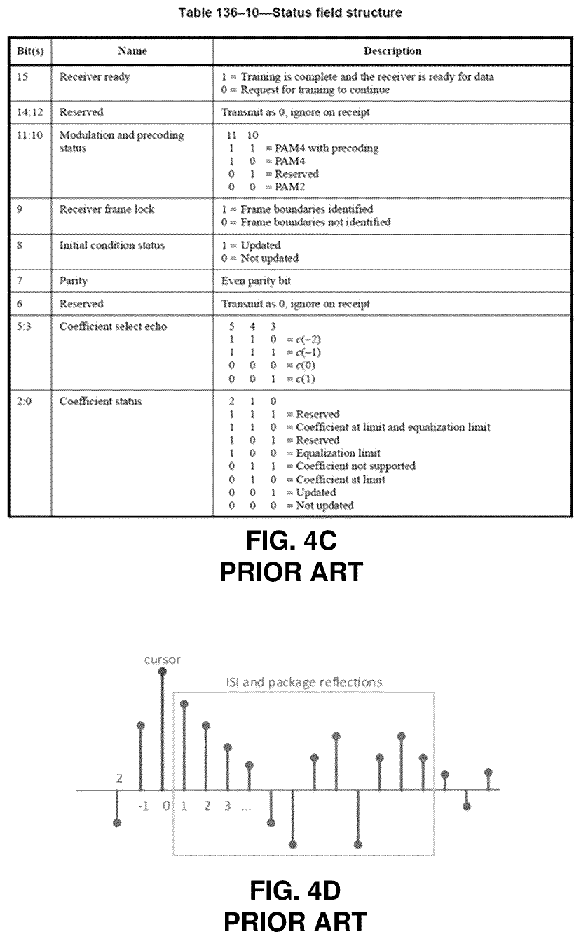

During TRAIN_LOCAL, based on the receiver determining to request the transmitter to adjust one or more equalizer (EQ) settings, at 310, the receiver can request change to transmitter coefficients can utilize Table 136-9 (replicated in FIG. 4B), bits 4-2, to request change to one or more transmitter FFE coefficients such as C−1 or C+1. The process can return to 306, where the receiver can adapt to the training signal generated based on adjusted transmitter coefficient settings.

During TRAIN_LOCAL, based on a receiver not determining to request the transmitter to adjust one or more equalizer (EQ) settings, at 320, a determination can be made whether to request precoding of a training signal or data signal based on DFE coefficient value magnitude. For example, a DFE can include 8 taps or other numbers of taps and a tap can have an associated coefficient value. For example, at 320, a determination can be made if |DFE coefficient|>threshold, where a DFE coefficient can refer to one or more DFE coefficient values. If a magnitude of one or more DFE coefficient values is larger than a threshold, then a current bit can affect a next bit and an incorrect decision can propagate to affect future bits. A correlation can exist between DFE coefficient values that are larger than the threshold and occurrence of a burst of errors. The threshold can be determined based on operator choice, system simulations, or lab characterization and can be based on hysteresis margin.

For example, FIG. 4D depicts an example pulse response at a receiver for channel equalization between two link partners. Inter-symbol interference (ISI) contributions due to package and connectors are shown in the post-cursor pulses after the cursor. A DFE at the receiver can target and attempt to cancel energy at unit intervals (UIs) after the main cursor (sample position). If these coefficients are too large, such that the risk of an incorrect sample causing a burst of errors by propagating this error via the coefficient applied to subsequent bits, precoding can be requested during 322 using a Control Frame as shown in FIG. 4B.

Section 135.7.2 of IEEE 802.3-2022 (replicated in FIG. 4A) provides non-limiting example manners of applied precoding. Precoding data can convert an error sequence into an entry and an exit error. If the sequence is 1 bit long, then precoding can lead to a 1 bit error creating 2 bit errors (an entry and an exit). Accordingly, enabling precoding where errors are randomly interspersed can lead to multiplication of the number of errors. Bit error rate feedback from the receiver during training can further qualify if precoding is to be enabled at a receiver. Where a known pattern is used during training, Forward Error Correction (FEC) at a receiver can compensate for errors to balance between enabling precoding or not enabling precoding and merely using FEC to correct errors.

Referring back to FIG. 3, during TRAIN_LOCAL, at 322, the receiver can request the transmitter to apply precoding. In some cases, precoding can be associated with PAM-4 or other signal modulation types such as Pulse Amplitude Modulation 6-level (PAM-6) or others. For example, the receiver can request a transmitter to apply PAM-4 with precoding by using bits 9 and 8 (modulation and precoding request (value 11)) in Table 136-9 (replicated in FIG. 4B). FIG. 4C depicts an example of TX responses to the Request PAM-4 with precoding using information in bits 11:10 of Table 136-10 to indicate use of PAM-4 with precoding.

Based on determining that a magnitude DFE coefficient is not larger than threshold and no precoding is to be applied by the transmitter, link training can be completed and a local version of receiver ready occurs. During TRAIN_REMOTE phase of FIG. 2, at 330, the receiver does not request the transmitter to apply precoding for transmitted training signals. For example, TRAIN_REMOTE can refer to a state in which the link training has completed.

In some examples, receiver (RX) equalizer (EQ) and/or transmitter (TX) EQ can be re-adapted and another determination of whether to apply precoding can occur during another training phase. For example, a training phase can occur periodically or at a request of a receiver or system administrator.

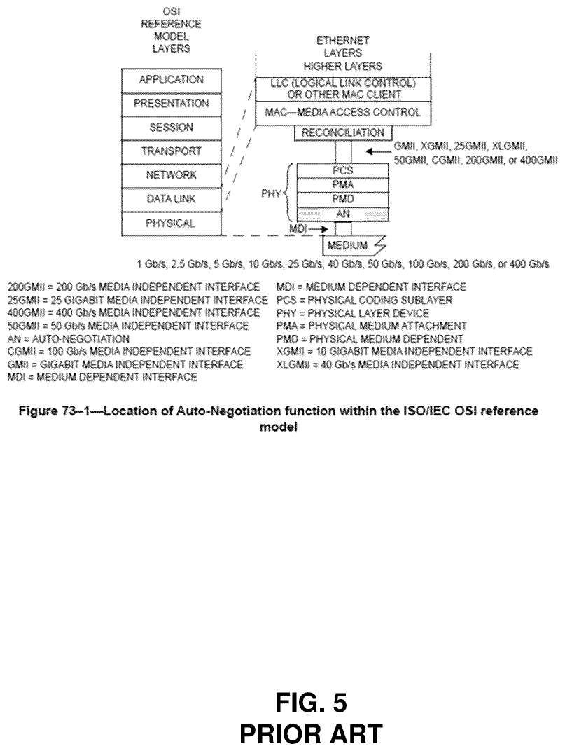

FIG. 5 depicts an example of potential use of an 400GMII (400 Gb/s media independent interface). Examples are not limited to this scenario. Various examples described herein can utilize a PMD that can determine whether to apply precoding can occur during another training phase, as described herein.

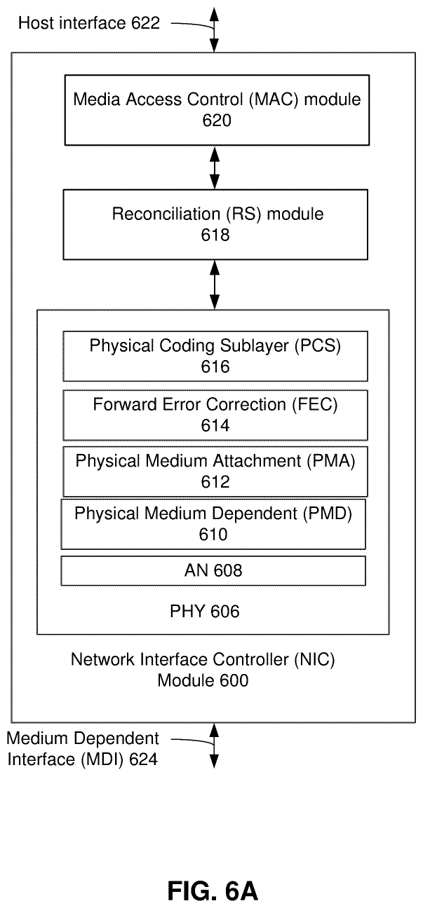

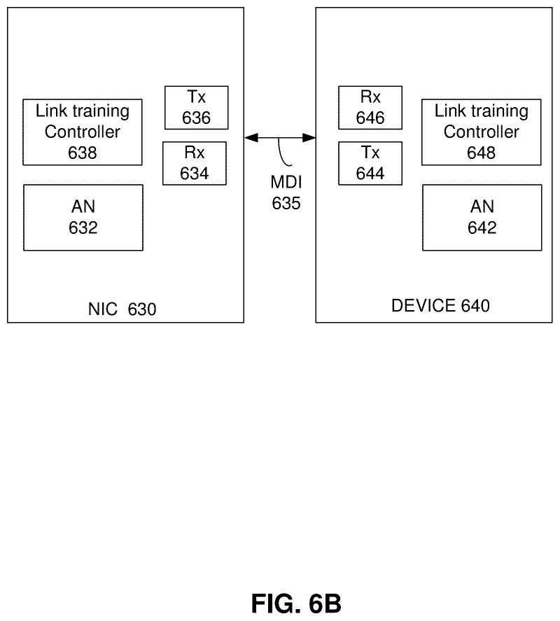

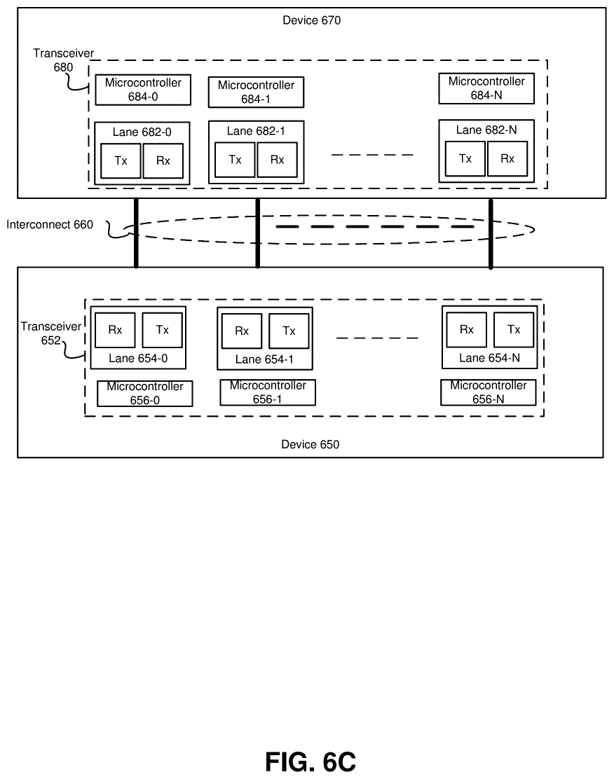

FIG. 6A is a block diagram illustrating Ethernet port circuitry in a network interface controller 600. The Ethernet port logic includes a Media Access Control (MAC) module 602, a reconciliation sublayer module 604 and a PHY module 606. The PHY module 606 can include a physical medium attachment (PMA) sublayer module 612, Physical Medium Dependent (PMD) sublayer 610, a forward error correction (FEC) module 614, and a physical coding sublayer (PCS) module 616.

Auto-Negotiation (AN) circuitry 608 can perform AN in a manner consistent with FIG. 73-1 of IEEE 802.3-2022. For example, AN circuitry 608 can advertise technology and FEC capabilities to a link partner using a base page and next page of message code 2, as described herein. In some examples, AN circuitry 608 can advertise capability to support 800GbE PHY, as described herein.

MAC module 620 is configured to transfer data to and from the PHY module 606. The Reconciliation Sublayer (RS) module 618 can provide a mapping operation that reconciles the signals at a Media Independent Interface (MII) to the Media Access Control (MAC)-Physical Signaling Sublayer (PLS) service definitions. MAC module 620 can be configured to implement aspects of the MAC layer operations and the RS module 618 can be configured to implement reconciliation sublayer operations.

Physical Medium Dependent (PMD) sublayer 610 can be responsible for interfacing to transmission medium, Medium Dependent Interface (MDI) 622. Some examples described herein to request a transmitter to use PAM-4 with precoding can be performed by PMD 610. Physical Medium Attachment (PMA) sublayer 612 can perform transmission, reception, signal detection, clock recovery and skew alignment. PMD 610 and PMA 612 can be configured to transmit and receive serial data over MDI 622.

In some examples, PMD 610 and PMA 612 can include or use a serializer de-serializer (SerDes). In some examples, link training and re-training can be provided to adjust filter parameters of a transmit and/or receive equalizer used by a SerDes. For example, a software SerDes driver executed by a processor in a host or a network interface can be used to change a transmit equalizer parameter. In some examples, any combination of hardware, software and/or firmware can be used to manage and perform link training and/or link re-training.

In some examples (e.g., for 100GBASE-CR1 or 100GBASE-KR1), FEC module 614 may decode data passed from the PMD 610 and PMA 612 to the PCS module 616 or encode data passed from the PCS module 616 to the PMD 610 and PMA 612a, 612b. In some examples, (e.g., for 200G and 400G modes), PCS module 616 includes FEC module 614. Forward error correction code may improve the reliability of data transmission at higher line speeds.

In the transmit direction, MAC module receives data to be transmitted over a host interface 622. MAC module 620 can receive data to be transmitted over a host interface 622. MAC module 620 can generate the MAC frame that includes inter-packet gap (IPG), preamble, start of frame delimiter (SFD), padding, and Cyclic Redundancy Check (CRC) bits in addition to the received data before passing the MAC frame to the PHY module 606. The PHY module 606 can encode the MAC frame for reliable serial transmission over the MDI 624.

In the receive direction, MAC module 620 can receive MAC frames over a data bus from PHY module 606. MAC module 620 can perform Ethernet frame detection and validation, cyclic redundancy check (CRC) validation, update statistics counters, strip out the CRC, preamble detection and removal, and start of frame delimiter (SFD) detection and removal, and forward the rest of the MAC frame that includes headers for other protocols to a next layer (for example, an Internet protocol (IP) layer) for processing. The PHY module 606 can decode the MAC frame received over the MDI 624.

FIG. 6B illustrates a simplified example of a transmitter-receiver pair for between a network interface controller 630 and a device 640. MDI 635 provides a link between network interface controller 630 and device 640 by transferring data in parallel over one or more lanes. Device 640 can be any device such as another NIC, a switch, router, a server, a host computing platform, and so forth. AN can be performed using AN 632 and 642.

Network interface controller 630 can include a host receiver 634 and a host transmitter 636 for at least one lane of an electrical link between the network interface controller 630 and device 640. Device 640 can include a module receiver 646 and module transmitter 644 for an electrical link between network interface controller 630 and device 640.

For example, link training controller 638 of NIC 630 can initiate or manage link establishment, link training, or link re-training operations as described herein. Link training controller 638 can be implemented as any or a combination of: a driver, microcontroller, or other software in a host or network interface.

Transmitter (Tx) 636/644 or receiver (Rx) 634/646 can use a SerDes to serialize or deserialize a signal. When a SerDes is turned on and a signal is received, Rx tuning can be used to improve the signal quality. When there is a time limit to perform Rx tuning, a signal is to be passed to a PCS layer within the time limit and the link comes-up if the link is acceptable. If the link does not pass, training can be restarted. In some examples, Tx 636-Rx 646 and/or Tx 644-Rx 634 can utilize independent Rx tuning. In some examples, an amount of time to perform equalizer tuning is the same for Tx 636-Rx 646 and/or Tx 644-Rx 634.

According to various examples, link training controller 638 can perform link training and selectively request a transmitter to use PAM-4 with precoding as described herein.

Communications between devices can occur using any protocol. For example, Ethernet frames can be sent by NIC 630 to device 640. For example, Ethernet frames can be sent by device 640 to NIC 630. An Ethernet frame can include one or more of: a preamble, start of frame delimiter (SFD), destination MAC address, source MAC address, EtherType field, length field, frame check sequence (e.g., cyclic redundancy check (CRC)), and payload.

FIG. 6C depicts an example system for communicatively coupling a network device to another network device. For example, device 650 and device 670 can include a network device such as one or more of: a network interface, switch, router, server, host computing platform, interconnect, fabric, rack, or any computing or communications device. For example, device 670 can be connected to an interface with multiple electrical links (e.g., backplane or copper cable). The system provides for multiple lanes of transmit-receive pairs that can be used to transmit or receive electrical signals between device 650 and device 670. A lane can transmit and/or receive a signal. A transmitter of a lane can use an equalizer implemented in an analog circuit to generate an electrical signal for transmission. The equalizer can have one or more current sources that are used to create a signal whereby weights of current sources can be adjusted to change signal characteristics. Equalizer settings can be modified to change weights of current sources. For example, a digital-to-analog converter (DAC) can be used to create signal in the digital domain and output the result in an analog format.

According to various examples, transceiver 680 can perform link training and selectively request a transmitter to use PAM-4 with precoding, as described herein. Transceiver 552 can perform similar operations as that of transceiver 680 with device 670 to perform link training and selectively request a transmitter to use PAM-4 with precoding, as described herein.

Various examples can use one or more of microcontrollers 684-0 to 684-N of device 670 to initiate and manage link training of transmitter and/or receiver equalizer settings with any of microcontrollers 656-0 to 656-N of device 650.

Transceiver 680 can be used for electrical signal transmission and receipt between device 670 and device 650. Transceiver 680 can provide multiple transmit and receive lanes for electrical signal communication between device 670 and device 650. For example, lanes 682-0 to 682-N can provide transmit and receive circuitry for coupling with receive and transmit circuitry of lanes 654-0 to 654-N of device 650. Lanes 682-0 to 682-N can provide serializer/deserializer (SerDes) formatting of signals. In some examples, transceiver 680 can be part of a PMD or PHY.

Device 670 can be communicatively coupled to device 650 by an interconnect 660. Interconnect 660 can be electrical signal conductors that couple pins or holes of lanes 682-0 to 682-N of a pluggable device 670 to holes or pins of lanes 654-0 to 654-N of device 650. Device 650 can transmit or receive signals in electrical format to or from device 670.

Device 650 can include transceiver 652 for communication with device 670. Transceiver 652 can include lanes 654-0 to 654-N where any of lanes 654-0 to 654-N includes receive and transmit circuitry. In some examples, transceiver 652 can be part of a PMD or PHY. Any microcontroller 656-0 to 656-N can be used to manage operation of its lane.

In some examples, a single microcontroller can manage equalizer settings of one or multiple lanes. The one or more parameters can cause a receiver or transmitter device in any of lanes 654-0 to 654-N to adjust its equalizer setting for a specific tap, whether to increase or decrease the coefficient value of an equalizer tap. In some examples, the settings of a tap can be adjusted independent of adjustment of settings of another tap.

In some examples, device 650 can request to change an equalizer setting of any tap of a transmitter equalizer circuit of device 670. Likewise, device 670 can request to change an equalizer setting of any tap of a transmitter equalizer circuit of device 650. Accordingly, device 670 and device 650 can adjust transmitter equalizer settings used by a partner device. Moreover, any of device 670 and device 650 can adjust receiver equalizer settings to compensate for channel distortions.

For example, to initiate an equalizer setting change, any microcontroller 684-0 to 684-N can determine a signal quality of a received signal and determine what transmitter side tap of device 650 to change and whether to increment or decrement the setting of the tap. For example, an eye opening of a received signal can be measured. A microcontroller can estimate inter-symbol interference (ISI) and select settings based on an ISI reaching a minimum value. A microcontroller can search through available transmitter tap settings and select settings that lead to a most open eye. Transmitter equalizer settings can be changed periodically starting at or after link startup and can run periodically. Similar operations can occur for microcontroller 656-0 to 656-N to adjust transmit equalizer settings of device 670.

Device 670 and/or device 650 can perform packet processing such as one or more of: media access control, any protocol layer processing, security, routing, destination lookup, and so forth.

FIG. 7 depicts a system that can perform link training. Host 700 can utilize network interface device 720 to communicate with host 760 via network interface device 770 using links 750. Optical and/or electrical signal propagation media can provide communication for links 750. Various examples of host 700 and host 760 are described with respect to FIG. 4 whereas various examples of network interface device 720 and network interface device 770 are described with respect to FIG. 5 and/or 6. Examples described herein can be used in 5G base station or cellular communication networks.

Host 700 can execute port configuration software 706 using one or more processors. Port configuration software 706 can be provided by a communications equipment manufacturer to manage operation of serializer-deserializer (SerDes) 732 that communicate using one or more of links 750. Port configuration 706 can enable use of one or more ports and establish links 750 between network interface device 720 and network interface device 770. Port configuration 706 can manage use of ports and links through a stack of APIs and drivers 708 that control the link Media Access Controllers (MAC) (not shown in FIG. 7) and physical layer interface (PHY) 730.

During training of links 750 using drivers and APIs 708, port configuration software 706 can configure operation of link monitoring circuitry 740 in PHY 730 of network interface device 720 to perform monitoring of one or more of links 750. In some examples, link monitoring circuitry 740 can be implemented as a processor or microcontroller executed process, field programmable gate array (FPGA), application specific integrated circuit (ASIC), or other programmable hardware device. Link monitoring circuitry 740 can monitor an eye height of analog signals received by a SerDes among SerDes 732 from a transmission medium (e.g., electrical or optical cable) or digital conversion of signal. Link monitoring circuitry 740 can perform link training and selectively request a transmitter to use PAM-4 with precoding as described herein.

Link monitoring can be port mode agnostic and can be used for Ethernet (e.g., IEEE 802.3-2018), Common Public Radio Interface (CPRI) (e.g., CPRI Specification v7.0 (2015)), Peripheral Component Interconnect express (PCIe) (e.g., PCI-SIG PCI Express (2015)) or another serial input output (IO) protocol.

Note that link monitoring can be utilized on one or both sides of a link. For example, PHY 780 can utilize link monitoring 782 that operates in a similar manner to link monitoring 740.

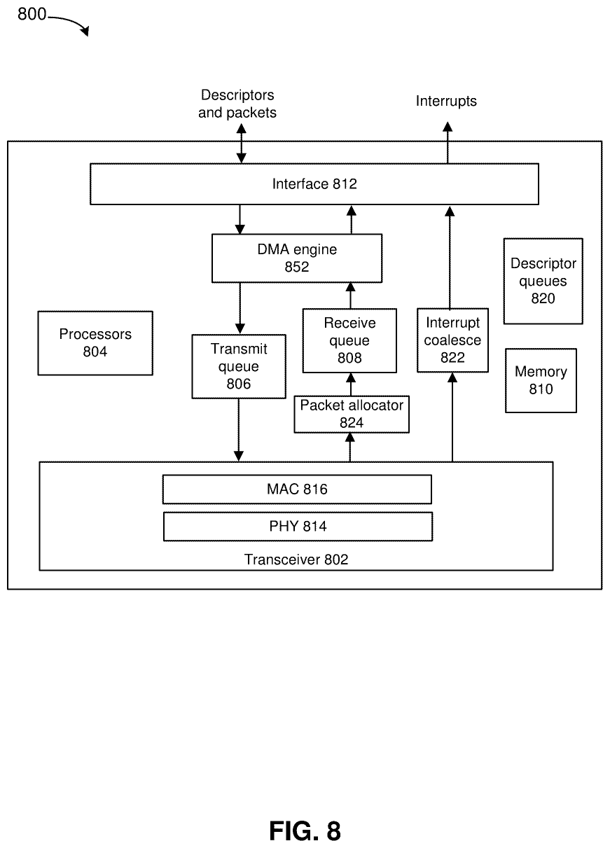

FIG. 8 depicts an example network interface. Various resources in the network interface can perform link training and selectively request a transmitter to use PAM-4 with precoding as described herein. Transceiver 802 can be capable of receiving and transmitting packets in conformance with the applicable protocols such as Ethernet as described in IEEE 802.3, although other protocols may be used. Transceiver 802 can receive and transmit packets from and to a network via a network medium (not depicted). Transceiver 802 can include PHY circuitry 814 and media access control (MAC) circuitry 816. PHY circuitry 814 can include encoding and decoding circuitry (not shown) to encode and decode data packets according to applicable physical layer specifications or standards.

In some examples, PHY 814 could select PRBS polynomials and/or seeds for use to generate training signals, as described herein. In some examples, PHY 814 can include a PMD to select PRBS polynomial and/or seed for training multiple lanes. Various resources in the network interface can perform link establishment, link training or link re-training in accordance with examples described herein.

MAC circuitry 816 can be configured to assemble data to be transmitted into packets, that include destination and source addresses along with network control information and error detection hash values. Processors 804 can be any a combination of a: processor, core, graphics processing unit (GPU), field programmable gate array (FPGA), application specific integrated circuit (ASIC), or other programmable hardware device that allow programming of network interface 800. For example, processors 804 can provide for identification of a resource to use to perform a workload and generation of a bitstream for execution on the selected resource. For example, a “smart network interface” can provide packet processing capabilities in the network interface using processors 804.

Packet allocator 824 can provide distribution of received packets for processing by multiple CPUs or cores using timeslot allocation described herein or RSS. When packet allocator 824 uses RSS, packet allocator 824 can calculate a hash or make another determination based on contents of a received packet to determine which CPU or core is to process a packet.

Interrupt coalesce 822 can perform interrupt moderation whereby network interface interrupt coalesce 822 waits for multiple packets to arrive, or for a time-out to expire, before generating an interrupt to host system to process received packet(s). Receive Segment Coalescing (RSC) can be performed by network interface 800 whereby portions of incoming packets are combined into segments of a packet. Network interface 800 provides this coalesced packet to an application.

Direct memory access (DMA) engine 852 can copy a packet header, packet payload, and/or descriptor directly from host memory to the network interface or vice versa, instead of copying the packet to an intermediate buffer at the host and then using another copy operation from the intermediate buffer to the destination buffer.

Memory 810 can be any type of volatile or non-volatile memory device and can store any queue or instructions used to program network interface 800. Transmit queue 806 can include data or references to data for transmission by network interface. Receive queue 808 can include data or references to data that was received by network interface from a network. Descriptor queues 820 can include descriptors that reference data or packets in transmit queue 806 or receive queue 808. Bus interface 812 can provide an interface with host device (not depicted). For example, bus interface 812 can be compatible with PCI, PCI Express, PCI-x, Serial ATA, and/or USB compatible interface (although other interconnection standards may be used).

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), on-premises data centers, off-premises data centers, edge network elements, fog network elements, and/or hybrid data centers (e.g., data center that use virtualization, cloud and software-defined networking to deliver application workloads across physical data centers and distributed multi-cloud environments).

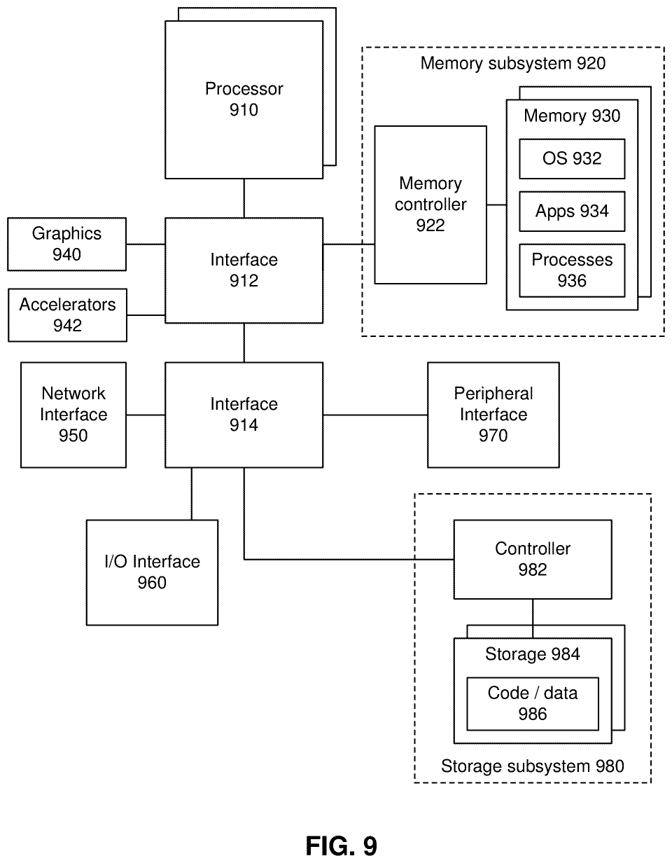

FIG. 9 depicts a system. Components of system 900 (e.g., processor 910, network interface 950, and so forth) to perform link training and selectively request a transmitter to use PAM-4 with precoding, as described herein. System 900 includes processor 910, which provides processing, operation management, and execution of instructions for system 900. Processor 910 can include any type of microprocessor, central processing unit (CPU), graphics processing unit (GPU), processing core, or other processing hardware to provide processing for system 900, or a combination of processors. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 900 includes interface 912 coupled to processor 910, which can represent a higher speed interface or a high throughput interface for system components that needs higher bandwidth connections, such as memory subsystem 920 or graphics interface components 940, or accelerators 942. Interface 912 represents an interface circuit, which can be a standalone component or integrated onto a processor die.

Accelerators 942 can be a fixed function or programmable offload engine that can be accessed or used by a processor 910. For example, an accelerator among accelerators 942 can provide compression (DC) capability, cryptography services such as public key encryption (PKE), cipher, hash/authentication capabilities, decryption, or other capabilities or services. In some examples, in addition or alternatively, an accelerator among accelerators 942 provides field select controller capabilities as described herein. In some cases, accelerators 942 can be integrated into a CPU socket (e.g., a connector to a motherboard or circuit board that includes a CPU and provides an electrical interface with the CPU). For example, accelerators 942 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 942 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Memory subsystem 920 represents the main memory of system 900 and provides storage for code to be executed by processor 910, or data values to be used in executing a routine. Memory subsystem 920 can include one or more memory devices 930 such as read-only memory (ROM), flash memory, one or more varieties of random access memory (RAM) such as static random-access memory (SRAM), dynamic random-access memory (DRAM), or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910.

In some examples, OS 932 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

In some examples, OS 932 or driver for network interface 950 can enable or disable network interface 950 to perform link training and selectively request a transmitter to use PAM-4 with precoding as described herein. In some examples, OS 932 or driver for network interface 950 can enable or disable network interface 950 indicating support for performing link training and selectively requesting a transmitter to apply PAM-4 with precoding on transmitted signals as described herein. Network interface 950 can indicate to OS 932 or driver capability to perform link training and selectively request a transmitter to use PAM-4 other modulation scheme with precoding as described herein. Network interface 950 can receive configurations and instructions (e.g., from OS 932 or driver) to perform or not perform link training and selectively request a transmitter to use PAM-4 or other modulation scheme with precoding as described herein.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 900 includes interface 914, which can be coupled to interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. In some examples, network interface 950 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 950 can include an Ethernet adapter, wireless interconnection components, cellular network interconnection components, USB (universal serial bus), or other wired or wireless standards-based or proprietary interfaces. Network interface 950 can transmit data to a device that is in the same data center or rack or a remote device, which can include sending data stored in memory.

Some examples of network interface 950 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 950 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONIC), Broadcom® Network Programming Language (NPL), NVIDIA® CUDA®, NVIDIA® DOCA™ Data Plane Development Kit (DPDK), OpenDataPlane (ODP), Infrastructure Programmer Development Kit (IPDK), x86 compatible executable binaries or other executable binaries, or others.

Some examples of network interface 950 can include PHY circuitry that can perform link training and selectively request a transmitter to use PAM-4 with precoding as described herein.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, or optical based disks, or a combination. Storage 984 holds code or instructions and data 986 in a persistent state (e.g., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (e.g., the value or state of the data is indeterminate if power is interrupted to system 900). In one example, storage subsystem 980 includes controller 982 to interface with storage 984. In one example controller 982 is a physical part of interface 914 or processor 910 or can include circuits or logic in both processor 910 and interface 914.

A volatile memory is memory whose state (and therefore the data stored in it) is indeterminate if power is interrupted to the device. A non-volatile memory (NVM) device is a memory whose state is determinate even if power is interrupted to the device.

In an example, system 900 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chip-to-chip communications, die-to-die communications, packet-based communications, communications over a device interface, fabric-based communications, and so forth. A die-to-die communications can be consistent with Embedded Multi-Die Interconnect Bridge (EMIB).

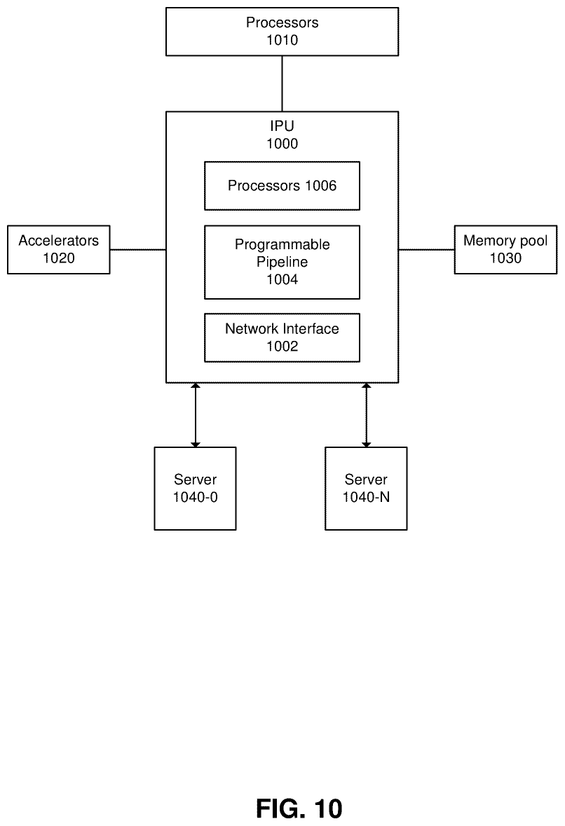

FIG. 10 depicts an example system. In this system, IPU 1000 manages performance of one or more processes using one or more of processors 1006, processors 1010, accelerators 1020, memory pool 1030, or servers 1040-0 to 1040-N, where N is an integer of 1 or more. In some examples, processors 1006 of IPU 1000 can execute one or more processes, applications, VMs, containers, microservices, and so forth that request performance of workloads by one or more of: processors 1010, accelerators 1020, memory pool 1030, and/or servers 1040-0 to 1040-N. IPU 1000 can utilize network interface 1002 or one or more device interfaces to communicate with processors 1010, accelerators 1020, memory pool 1030, and/or servers 1040-0 to 1040-N. IPU 1000 can utilize programmable pipeline 1004 to process packets that are to be transmitted from network interface 1002 or packets received from network interface 1002. IPU 1000 can include PHY circuitry that can perform link training and selectively request a transmitter to use PAM-4 with precoding, as described herein.

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade can include components common to conventional servers, including a main printed circuit board (main board) providing internal wiring (e.g., buses) for coupling appropriate integrated circuits (ICs) and other components mounted to the board.

In some examples, network interface and other examples described herein can be used in connection with a base station (e.g., 3G, 4G, 5G and so forth), macro base station (e.g., 5G networks), picostation (e.g., an IEEE 802.11 compatible access point), nanostation (e.g., for Point-to-MultiPoint (PtMP) applications), micro data center, on-premise data centers, off-premise data centers, edge network elements, fog network elements, and/or hybrid data centers (e.g., data center that use virtualization, serverless computing systems (e.g., Amazon Web Services (AWS) Lambda), content delivery networks (CDN), cloud and software-defined networking to deliver application workloads across physical data centers and distributed multi-cloud environments).

For example, link establishment, link training or link re-training can be applied by a base station that supports communications using wired or wireless protocols (e.g., 3GPP Long Term Evolution (LTE) (4G) or 3GPP 5G), on-premises data centers, off-premises data centers, edge network elements (computing elements provided physically closer to a base station or network access point than a data center), fog network elements (computing elements provided physically closer to a base station or network access point than a data center but further from an edge network), and/or hybrid data centers (e.g., data center that use virtualization, cloud and software-defined networking to deliver application workloads across physical data centers and distributed multi-cloud environments). Network or computing elements can be used in local area network (LAN), metropolitan area network (MAN), network with devices connected using optical fiber links, campus area network (CAN), or wide area network (WAN).

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example. Any aspect described herein can be combined with any other aspect or similar aspect described herein, regardless of whether the aspects are described with respect to the same figure or element. Division, omission or inclusion of block functions depicted in the accompanying figures does not infer that the hardware components, circuits, software and/or elements for implementing these functions would necessarily be divided, omitted, or included in an example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative examples. Furthermore, additional operations may be added or removed depending on the particular applications. Any combination of changes can be used and one of ordinary skill in the art with the benefit of this disclosure would understand the many variations, modifications, and alternative examples thereof.

Disjunctive language such as the phrase “at least one of X, Y, or Z,” unless specifically stated otherwise, is otherwise understood within the context as used in general to present that an item, term, etc., may be either X, Y, or Z, or combination thereof (e.g., X, Y, and/or Z). Thus, such disjunctive language is not generally intended to, and should not, imply that certain examples require at least one of X, at least one of Y, or at least one of Z to each be present. Additionally, conjunctive language such as the phrase “at least one of X, Y, and Z,” unless specifically stated otherwise, should also be understood to mean X, Y, Z, or combination thereof, including “X, Y, and/or Z.”

Illustrative examples of the devices, systems, and methods disclosed herein are provided below. An example of the devices, systems, and methods may include one or more, and combination of, the examples described below.

Example 1 includes one or more examples and includes an apparatus comprising: Ethernet physical layer transceiver (PHY) circuitry for use in frame communication with a remote link partner, the Ethernet PHY circuitry comprising: Physical Medium Dependent (PMD) circuitry; and transmitter circuitry and receiver circuitry for use in the frame communication, wherein: the PMD circuitry is to perform link training with a partner transmitter and selectively request the partner transmitter to apply a modulation scheme with precoding during the link training based on a magnitude of one or more equalizer coefficient values, the modulation scheme comprises Pulse Amplitude Modulation 4-level (PAM-4) or Pulse Amplitude Modulation 6-level (PAM-6), and the request the partner transmitter to apply the modulation scheme with precoding during the link training comprises transmission of a control signal to the partner transmitter.

Example 2 includes one or more examples, wherein the control signal comprises a modulation and precoding request.

Example 3 includes one or more examples, wherein the equalizer coefficient values comprise one or more of: Decision Feedback Equalizer (DFE) pre-cursor coefficient values, main coefficient values, or post-cursor coefficient values, feed forward equalizers (FFEs) coefficient values, or Maximum Likelihood Sequence Estimation (MLSE) equalizer coefficient values.

Example 4 includes one or more examples, wherein the PMD circuitry is to not request the partner transmitter to use a modulation scheme with precoding based on a magnitude of one or more equalizer coefficient values.

Example 5 includes one or more examples, and includes circuitry to apply forward error correction (FEC) to correct errors in a received signal from the partner transmitter.

Example 6 includes one or more examples, and includes circuitry to request equalizer setting adjustment by the partner transmitter based on the link training.

Example 7 includes one or more examples, and includes a non-transitory computer-readable medium comprising instructions stored thereon, that if executed by one or more processors, cause the one or more processors to: execute an operating system (OS) to configure circuitry of a network interface device to: enable performance of link training and selectively request a partner transmitter to use a modulation scheme with precoding during the link training based on a magnitude of one or more equalizer coefficient values.

Example 8 includes one or more examples, wherein the modulation scheme comprises Pulse Amplitude Modulation 4-level (PAM-4) or Pulse Amplitude Modulation 6-level (PAM-6).

Example 9 includes one or more examples, wherein the request the partner transmitter to apply the modulation scheme with precoding during the link training is based on transmission of a control signal to the partner transmitter.

Example 10 includes one or more examples, wherein the control signal comprises a modulation and precoding request.

Example 11 includes one or more examples, wherein the equalizer coefficient values comprise one or more of: Decision Feedback Equalizer (DFE) pre-cursor coefficient values, main coefficient values, or post-cursor coefficient values, feed forward equalizers (FFEs) coefficient values, or Maximum Likelihood Sequence Estimation (MLSE) equalizer coefficient values.

Example 12 includes one or more examples, wherein the circuitry is to not request the partner transmitter to use a modulation scheme with precoding based on a magnitude of one or more equalizer coefficient values.

Example 13 includes one or more examples, wherein the OS is to selectively disable the circuitry of the network interface device from use of a modulation scheme with precoding during the link training based on a magnitude of one or more equalizer coefficient values.

Example 14 includes one or more examples, and includes a method that includes Physical Medium Dependent (PMD) circuitry performing link training with a partner transmitter and selectively request the partner transmitter to apply a modulation scheme with precoding during the link training based on a magnitude of one or more equalizer coefficient values, wherein the modulation scheme comprises Pulse Amplitude Modulation 4-level (PAM-4) or Pulse Amplitude Modulation 6-level (PAM-6).

Example 15 includes one or more examples, wherein the request the partner transmitter to apply the modulation scheme with precoding during the link training is based on transmission of a control signal to the partner transmitter.

Example 16 includes one or more examples, wherein the control signal comprises a modulation and precoding request.

Example 17 includes one or more examples, wherein the equalizer coefficient values comprise one or more of: Decision Feedback Equalizer (DFE) pre-cursor coefficient values, main coefficient values, or post-cursor coefficient values, feed forward equalizers (FFEs) coefficient values, or Maximum Likelihood Sequence Estimation (MLSE) equalizer coefficient values.

Example 18 includes one or more examples, and includes the PMD circuitry not requesting the partner transmitter to use a modulation scheme with precoding based on a magnitude of one or more equalizer coefficient values.

Example 19 includes one or more examples, and includes requesting equalizer setting adjustment by the partner transmitter based on the link training.

1. An apparatus comprising:
Ethernet physical layer transceiver (PHY) circuitry for use in frame communication with a remote link partner, the Ethernet PHY circuitry comprising:
Physical Medium Dependent (PMD) circuitry; and
transmitter circuitry and receiver circuitry for use in the frame communication, wherein:
the PMD circuitry is to perform link training with a partner transmitter and selectively request the partner transmitter to apply a modulation scheme with precoding during the link training based on a magnitude of one or more equalizer coefficient values,
the modulation scheme comprises Pulse Amplitude Modulation 4-level (PAM-4) or Pulse Amplitude Modulation 6-level (PAM-6), and
the request the partner transmitter to apply the modulation scheme with precoding during the link training comprises transmission of a control signal to the partner transmitter.

2. The apparatus of claim 1, wherein the control signal comprises a modulation and precoding request.

3. The apparatus of claim 1, wherein the equalizer coefficient values comprise one or more of: Decision Feedback Equalizer (DFE) pre-cursor coefficient values, main coefficient values, or post-cursor coefficient values, feed forward equalizers (FFEs) coefficient values, or Maximum Likelihood Sequence Estimation (MLSE) equalizer coefficient values.

4. The apparatus of claim 1, wherein the PMD circuitry is to not request the partner transmitter to use a modulation scheme with precoding based on a magnitude of one or more equalizer coefficient values.

5. The apparatus of claim 4, comprising circuitry to apply forward error correction (FEC) to correct errors in a received signal from the partner transmitter.

6. The apparatus of claim 1, comprising circuitry to request equalizer setting adjustment by the partner transmitter based on the link training.

7. A non-transitory computer-readable medium comprising instructions stored thereon, that if executed by one or more processors, cause the one or more processors to:
execute an operating system (OS) to configure circuitry of a network interface device to:
enable performance of link training and selectively request a partner transmitter to use a modulation scheme with precoding during the link training based on a magnitude of one or more equalizer coefficient values.

8. The computer-readable medium of claim 7, wherein the modulation scheme comprises Pulse Amplitude Modulation 4-level (PAM-4) or Pulse Amplitude Modulation 6-level (PAM-6).

9. The computer-readable medium of claim 7, wherein the request the partner transmitter to apply the modulation scheme with precoding during the link training is based on transmission of a control signal to the partner transmitter.

10. The computer-readable medium of claim 9, wherein the control signal comprises a modulation and precoding request.

11. The computer-readable medium of claim 7, wherein the equalizer coefficient values comprise one or more of: Decision Feedback Equalizer (DFE) pre-cursor coefficient values, main coefficient values, or post-cursor coefficient values, feed forward equalizers (FFEs) coefficient values, or Maximum Likelihood Sequence Estimation (MLSE) equalizer coefficient values.

12. The computer-readable medium of claim 7, wherein the circuitry is to not request the partner transmitter to use a modulation scheme with precoding based on a magnitude of one or more equalizer coefficient values.

13. The computer-readable medium of claim 7, wherein the OS is to selectively disable the circuitry of the network interface device from use of a modulation scheme with precoding during the link training based on a magnitude of one or more equalizer coefficient values.

14. A method comprising:
Physical Medium Dependent (PMD) circuitry performing link training with a partner transmitter and selectively request the partner transmitter to apply a modulation scheme with precoding during the link training based on a magnitude of one or more equalizer coefficient values, wherein the modulation scheme comprises Pulse Amplitude Modulation 4-level (PAM-4) or Pulse Amplitude Modulation 6-level (PAM-6).

15. The method of claim 14, wherein the request the partner transmitter to apply the modulation scheme with precoding during the link training is based on transmission of a control signal to the partner transmitter.

16. The method of claim 15, wherein the control signal comprises a modulation and precoding request.

17. The method of claim 14, wherein the equalizer coefficient values comprise one or more of: Decision Feedback Equalizer (DFE) pre-cursor coefficient values, main coefficient values, or post-cursor coefficient values, feed forward equalizers (FFEs) coefficient values, or Maximum Likelihood Sequence Estimation (MLSE) equalizer coefficient values.

18. The method of claim 14, comprising:
the PMD circuitry not requesting the partner transmitter to use a modulation scheme with precoding based on a magnitude of one or more equalizer coefficient values.

19. The method of claim 14, comprising:
requesting equalizer setting adjustment by the partner transmitter based on the link training.
